(19) United States
(12) Patent Application Publication
(10) Pub. No.: US 2008/0293392 A1
(43) Pub. Date: Nov. 27, 2008

(54) Reminder Notification System and Method

(76) Inventor: Dane A. Strother, Potomac, MD (US)

Correspondence Address: CAPITAL LEGAL GROUP, LLC, 1100 River Bay Road, Annapolis, MD, 21409, US

(21) Appl. No.: 12/123,770

(22) Filed: May 20, 2008

Related U.S. Application Data
(60) Provisional application No. 60/939,170, filed on May 21, 2007.

(51) Int. Cl. H04M 3/42; G08B 1/00

(52) U.S. Cl. 455/414.2; 340/309.7

(57) ABSTRACT

A system and method of providing medication reminder notifications to a plurality of users is provided. In one embodiment, the method comprise storing data of mobile telephone number for each of the plurality of users in a memory, storing medication data in association with each of the plurality of users in a memory that comprises information identifying one or more medications of the user. The method may further include storing notification schedule data in association with each user in a memory that comprises information for determining one or more times for providing a medication reminder notification that comprises a reminder to take a medication, determining medication content for a medicine reminder notification based, at least in part, on the medication data in association with that user; and transmitting one or more medication reminder notifications, that include the determined medication content, to the mobile telephone number(s) destinations associated with each user according to the notification schedule data associated with the user.

### CROSS REFERENCE TO RELATED APPLICATIONS

This application claims priority to U.S. Provisional Patent Application No. 60/939,170, filed May 21, 2007, which is incorporated herein by reference in its entirety.

### FIELD OF THE INVENTION

The present invention generally relates to systems and methods for providing reminder notifications, and more particularly to systems and methods for creating, managing and communicating reminder content to customers and customer devices over a communication network.

### BACKGROUND OF THE INVENTION

In modern society people have many commitments, obligations, and appointments. People have routine tasks and complex tasks. Keeping track of specific time commitments can be a challenge. Some people may be too busy. Others simply may have a lapse in memory. In either case, there may be instances when a person forgets to perform a task at a designated time. While this may be tolerable for some tasks, tardiness in performing other tasks or not performing some other tasks is not tolerable. For example, in many instances it is extremely important for a person to take the correct medication and the proper amount of the medication at a designated time.

It is therefore desirable to provide an easy to manage and cost effective reminder system that may be used, such as by businesses, to assist customers in using business services.

### SUMMARY OF THE INVENTION

The present invention provides system and a method of providing notifications to a plurality of users. In one embodiment, the method comprises storing in a memory a mobile telephone number associated with each of the plurality of customers; storing in a memory one or more notification times for each customer; storing information of a medication associated with each customer; constructing a notification that includes information of the medication associated with each customer; at each notification time associated with each customer, transmitting the notification, as a text message to the mobile telephone number associated with that customer. The method may further include receiving a text message reply from the mobile phone of the customer that acknowledges receipt of the reminder.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an example network configuration for a reminder service, according to an example embodiment of the present invention;

FIG. 2 is a data and functional flow diagram for a reminder service, according to an example embodiment of the present invention;

FIG. 3 is a flow chart of content setup scheduling processes performed by a vendor and/or reminder service provider, according to an example embodiment of the present invention;

FIG. 4 is a flow chart of scheduling processes performed by a reminder service provider, according to an example embodiment of the present invention;

FIG. 5 is a flow chart of communication processes performed by a reminder service provider, according to an example embodiment of the present invention;

FIG. 6 is a flow chart of processes performed at a user device, according to an example embodiment of the present invention; and

FIGS. 7a-b are example text message reminder notifications that include reminder content and advertising content, according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, enterprise applications, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

According to an example embodiment of the present invention, a commercial service provider, such as a pharmacy or car rental dealer, compiles customer information for use in sending reminders, advertisements and other information to the customer. Depending on the customer preferences or type of reminder service offered, the communications may take the form of a text message, instant message, email communication, and/or automated voice message. In some applications, communications can be sent in multiple formats to multiple devices. A text message may be sent to any device supporting text messaging, such as a mobile telephone, smart phone, or personal digital assistant (PDA). Similarly, an instant message may be sent to any computing device supporting instant messaging, and an email may be sent to any computing device supporting email. An automated voice message may be synthesized and sent to a home phone, mobile phone or other device capable of receiving voice communications.

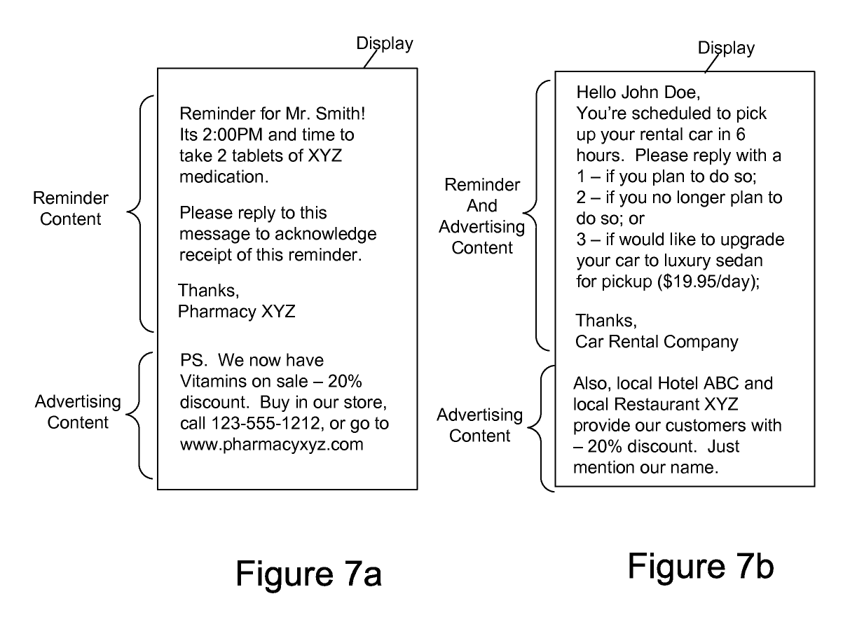

In various embodiments of the present invention, the reminder may be adapted to the customer. In addition, an advertisement or other accompanying information may be selected and included with the reminder. The advertisement may be adapted according to information about the commercial service provider, the provider's goods and services, and/or the customer. For example, a pharmacy may offer to send reminders to their customers that identify the medication, the amount of the medication, and/or the time the medication is to be take. For example, the text may read “It is now time to take one tablet of XYZ.” In addition, the message may include safety information related to the medication being taken (e.g., do not take the XYZ medication with alcohol and do not drive a vehicle) and/or an advertisement that relates to products and/or services of the pharmacy. Another example of a reminder notification sent to the mobile phone, PDA, or other personal communication device is illustrated in FIG. 7a. A car rental dealer may send a reminder of the customer's reservation and attach a promotion to upgrade the reservation to another class of vehicle. A car rental example notification is illustrated in FIG. 7b. Customer history and demographics may be used to determine the type of advertisement to include.

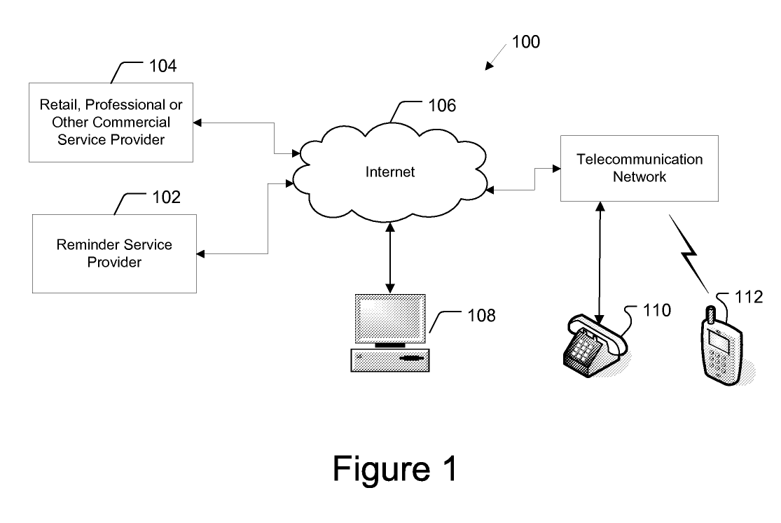

FIG. 1 illustrates an exemplary configuration for a notification system 100 according to an example embodiment of the present invention. A reminder notification service provider 102 may manage reminders for a commercial service provider 104, such as a pharmacy, car rental deal, or other retail, wholesale, business, professional service provider. In some embodiments the business 104 may operate as their own reminder service provider 104, managing the reminder service without the assistance of a separate reminder service provider. The commercial service provider 104 may upload data via the internet 106 to the reminder service provider 102, such as customer information, message templates, advertisements, informational messages, and the like. The reminder notification service provider 102 may manage communications with the customers to provider reminder notifications. Reminder notifications (also referred to herein simply as “reminders”) may be sent over the internet 106 to a customer's personal computer 108, or through a telecommunication network 110 to a user device, such as a telephone 112 or mobile telecommunication device 114, (e.g., mobile telephone, PDA, smart phone). Reminder notifications sent in the form of text messages (SMS) may be sent via a mobile telephone network to the user's mobile telephone or other mobile communication device.

As discussed the notifications may include reminder content and advertising content. As illustrated in FIG. 7a the advertising content may be appended to the end of the reminder content and may appear as a “PS” to the reminder content in order induce the recipient to read the advertisement. In addition, the notifications may include a request for acknowledgement of the reminder (e.g., via a reply message). If no acknowledgment is received, the notification may be re-transmitted as discussed below. In addition and as illustrated in FIG. 7b, the advertising content may be embedded in (i.e., not separated from) the reminder content. Further, the notification may include advertisements from multiple venders as illustrated in FIG. 7b, which includes an advertisement from the Car Rental Company, Hotel ABC and Restaurant XYZ, and wherein the venders are local venders to the location where the car is to be picked up.

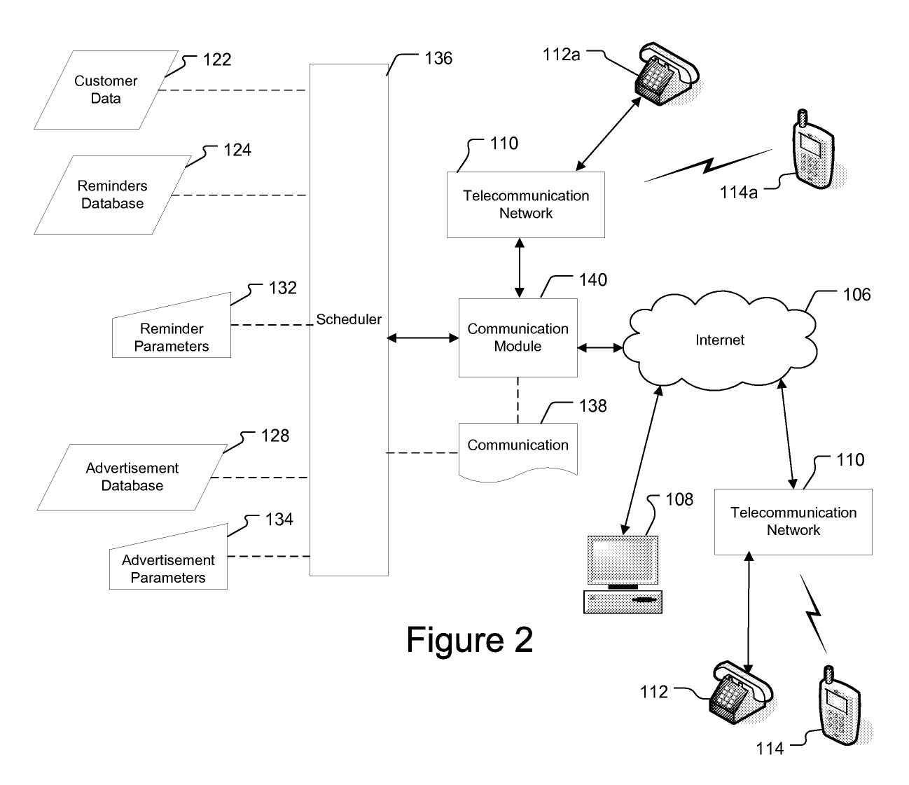

FIG. 2 shows a data and functional flow of the reminder notification system 100 according to an example embodiment of the present invention. Several databases 122-128 and parameter sets 132-134 may be accessed by a scheduler 136 to create a communication 138. The communication 138 may include a reminder message and an advertisement or other informational message. A communication module 140 transmits communications 138 via a communication network 106 (e.g., the internet or a mobile telephone network) according to timing parameters set for each given communication 138. A given communication 138 is directed to one or more customer devices such as a personal computer 108, telephone 112, or mobile communication device 114. In some instances the communication 138 may be transmitted onto a telecommunication network 110, such as a wireless mobile telephone network or the public switched telephone network en route to the customer device. As illustrated in FIG. 2, communications from the communication module 140 to and from at least some the user devices 112a, 114a need not traverse the internet 106 and may be communicated to the appropriate telecommunication network 110 more directly from the communication module 140.

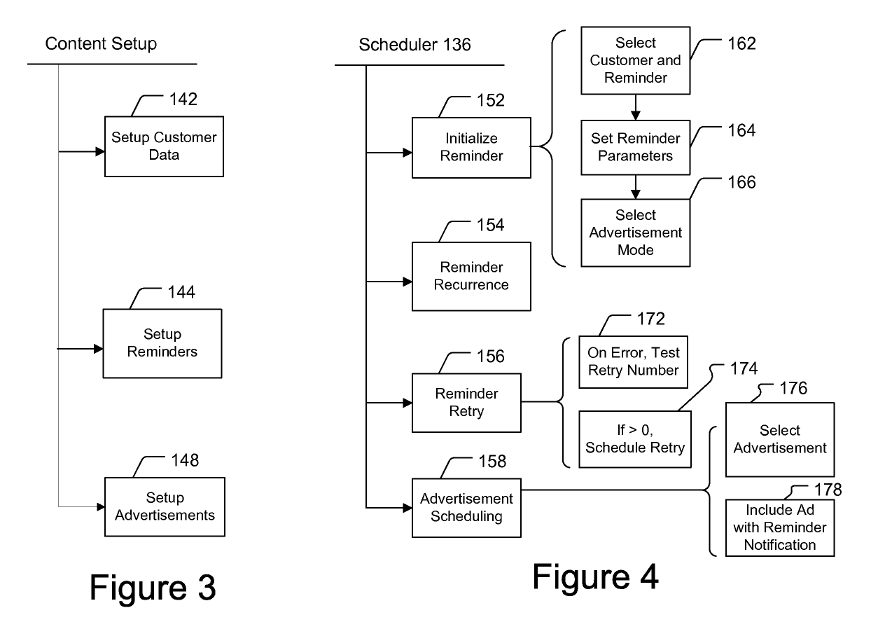

FIGS. 3-6 show exemplary processes for implementing the reminder notification system 100. As shown in FIG. 3, there are various content setup processes 142, 144 and 148 for establishing and maintaining the databases 122-128 of FIG. 2. For example, a process 142 may be executed to input, edit and maintain customer data in the customer database 122. Preferably, the customer database 122 includes at least one or more of a mobile telephone number, home telephone number, work telephone number, IM address, and/or email address to which reminders are sent. Other information, such as demographic information (e.g., age and sex) and customer history and location also may be maintained in the customer database 122. In an example embodiment, the commercial service provider 104 may interact with the system through this process 142 to maintain customer information and preferences. For example, some of this information may be collected by pharmacy personnel from the customer when the customer purchases subscription medications. In some embodiments, the customer may have password-enabled access (via the Internet) or other security-protected access to their records in the customer database 142, and be permitted to update their demographic data, contact information and preferences.

A process 144 may be executed to setup and maintain content for the reminders database 124. The reminders database 124 may include information used for scheduling reminders as well as message content that may be used for various customers. For example, pharmacy personnel may enter information of the subscription medication purchased by the customer as well as information as to how frequently the customer should take the medication. For example, the pharmacy personnel may enter (into a computer for storage in the database 124) the name (or other identifying information) of the medication(s) and that the user should take two tablets (quantity) three times per day (frequency). Alternately the frequency for taking the medication and/or quantity may be retrieved via the computer from a medications database. The pharmacy personnel may also ask the customer what times he or she would like to receive the first reminder (e.g., 8 AM) or each of the reminders (e.g., which may be 8 AM, 3:30 PM and 11 PM) and enters the information. The pharmacy personnel may also ask the user what time periods the customer does not wish to receive any reminders (e.g., 9 AM-5 PM or 11 PM-5 AM), which may be supplied to the database. The pharmacy personnel may also enter information of the date of expiration of the prescription (e.g., used to inform the customer of expiration of the prescription) and/or the date on which the customer should finish consuming the medication provided (e.g., used to remind the customer to order a refill).

Another process 148 may be executed to setup and maintain advertisement and information content for the advertisement database 128. For example, the commercial service provider 102 may supply various advertising content to the advertisement database 128 to be included with the reminders. In various embodiments the commercial service provider 104 and reminder notification service provider 102 may have access to the reminder databases and advertisement databases via the processes 144-148 to maintain the reminder, advertisement and informational content.

As shown in FIG. 4, the scheduler 136 may include various processes for creating and managing reminders. In one embodiment the scheduler 136 may include a process 152 for initializing a reminder, another process 154 for managing reminder recurrences, another process 156 for managing reminder retries, and another process 158 for compiling an advertisement and/or informational content with a reminder to form a communication. In various embodiments, the initialize reminder process 152 may be initiated by the commercial service provider 104, reminder service provider 102 or customer. In one embodiment, the reminders (and other processes) are initiated according one or more algorithms stored on and executing on one or more programmable computer systems. At step 162, the customer and the reminder are selected. At step 164, parameters are set for the reminder (e.g., determine the type of message(s) sent such as text message, email, etc.). In a specific embodiment the reminder parameters may include one or more of the following parameters: content of the reminder (e.g., please take two tablets of medication XYZ); the time and date to send the first reminder; the type of destination address and message to be sent (e.g., phone number; IM address; email address); the destination address (e.g., phone number; IM address; email address); the number of recurrences; the recurrence time interval; the number of retries in the event of an error or failed attempt; and a user password for cancelling or modifying the reminder. In some embodiments further customization of the recurrence parameters may be allowed. For example, recurrence may be set to none, daily, weekly, monthly, or annually. Recurrences may be set to repeat every “x” number (e.g., 1, 3, 5, 7, 30) of days or every weekday. The end of the recurrences may be set so that the reminders end after “x” recurrences, on a specific date, or so that recurrences do not end. At step 166, an advertising mode may be set. In some embodiments this step 166 may be automated and unavailable to the customer for modification. In some embodiments there are various advertising modes, which may include for example, ad of the day, random ad selection, or intelligent (targeted) ad selection. The specific advertisement or informational content may be selected by the advertisement scheduling process 158.

The reminder recurrence process 154 manages reminder recurrences for active reminders. For example, a reminder is scheduled for the next (subsequent) transmission according to the time, date and destination of the reminder parameters. The reminder retry process 156 manages retries for transmitted reminders. For some outgoing communications the communication module 140 waits for a confirmation (e.g., a text message or email reply message) after sending the communication. If confirmation is not received, or a transmission error is detected, then the reminder notification retry process 156 may be executed. At step 172 the retry number may be tested. If the retry number for the failed communication is greater than zero, then the retry number is decremented and a retry is scheduled. If the retry number is zero, then the reminder communication failed and further retries are not scheduled (although recurrence scheduling may remain unchanged).

The advertising scheduling process 158 selects an advertisement and/or other informational content to attach to or include with the reminder notification to form the communication to be transmitted to the customer. For convenience, the terms advertisement and ad are used below to refer to an advertisement although the substantially same process may be applicable in many embodiments for providing informational content. An advertisement, for example, may be selected at step 176 from the advertisement database 128 according to one or more advertising parameters. The parameter(s) may specify a mode, such as selecting the ad of the day, selecting a random ad, selecting a targeted ad (e.g. based on the user demographic information) and attach the resulting ad. The type of destination may also determine the formatting of the ad (e.g., email versus text message). The ad parameters also may include parameters for use in performing targeted ad selection. Customer history, customer demographics, customer location (e.g., residence), the product or service pertaining to the reminder, and/or other criteria may be used to select an ad to be included with the reminder. For example, for a pharmacy (or store that includes a pharmacy) an advertisement (which may include coupons) may be selected identifying one or more products that are one sale at the pharmacy (or store). Consequently, if an example customer gets three reminders per day, that customer may receive three (or more) advertisements for products and/or services from that pharmacy (or other businesses) per day. The advertisements (whether sold to other businesses or used to increase revenues to the pharmacy) may be used to off set the cost of or completely pay for the reminder notification system to thereby provide the notification service to customers free of charge or at a reduced (subsidized) fee.

In some embodiments, the advertisement scheduling process is performed during the initialization of the reminder (e.g., see step 166). In other embodiments, the advertisement scheduling process 158 may be re-performed to update the ad selection during the recurrence scheduling of retry scheduling processes. Once the advertisement or other informational content is selected, the content is attached to or included in the reminder at step 178.

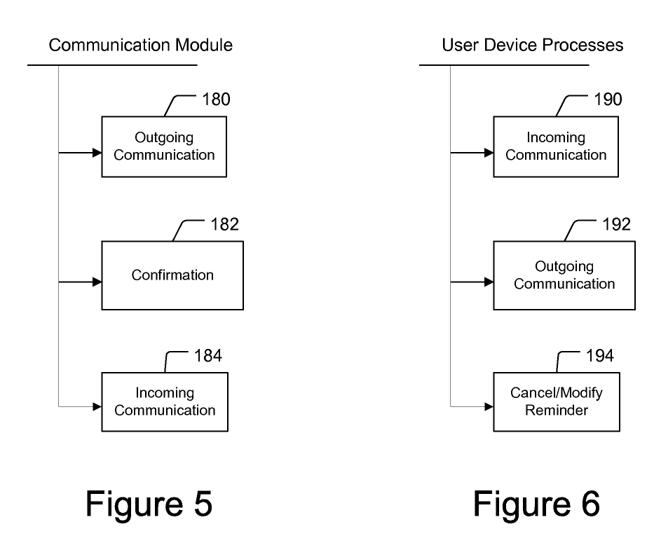

FIG. 5 shows the communication module 140. The outgoing communication process 160 may determine the time and date parameters for the next transmission of all active reminders. When such time and date is reached, the reminder is transmitted. The confirmation process 182 (if employed) may respond to transmission errors and process transmission confirmations to determine whether to execute the reminder retry process 156 for a given communication. In some embodiments, the user device 114 may send return communications (e.g., reply to an email or text message). In such embodiments, an incoming communication process 184 processes the incoming communication. For example, the process 184 may direct the communication (or the content of its communications) to the commercial service provider 104, reminder service provider 102 or an automated process for handling and further action or response.

FIG. 6 illustrates user device processes. Incoming communications may be handled by the incoming communication process 190. For example, a text message or email message may be stored, or an IM may be displayed. Text messages may be sent using short messaging service (SMS), a telecommunications protocol that allows the sending of “short” (160 characters or less) text messages. It is available on most digital mobile phones and some personal digital assistants with onboard wireless telecommunications. The individual messages may be referred to as text messages, and more colloquially SMSes, texts, or even txts (as in “text speak”). For Instant messaging (IM), an instant messaging client application may connect to an instant messaging service. In some cases, the received message (text message, IM or e-mail) may be converted by a speech synthesizer into a voice message.

In some embodiments, the message (the reminder and/or advertisement) may request the customer respond to the message. For example, a car rental dealer reminding the customer of a pickup time, data and place may offer the customer an upgrade. One or more outgoing communication processes 192 may prepare and send the response as are known in the art. In another example, the customer is asked to reply to the text message to thereby provide an acknowledgement that the customer received the reminder (e.g., to take a medication)

In some embodiments, the customer may have the ability to cancel or modify the reminders (or the acknowledgements so that the notifications are not re-transmitted). The cancel/modify reminder processes 194 may include a process that implements a user interface for handling such features, and another process for packaging or sending the ‘cancel’ or ‘modify’ instructions. As discussed, the user device may also include a confirmation process (not shown) wherein the customer sends a reply (e.g. a blank reply text message) to indicate that the reminder notification was received.

In one implementation of the reminder system 100, a pharmacy allows its customers to receive reminders for taking their medications. For example, when filling the prescription, the pharmacist may select a reminder message for the customer. In some embodiments, the scheduling process is automated so as to use the prescription information to select the message, the time for each reminder and the recurrence parameters. For example, if the prescription includes 60 capsules and a dosage of 2 capsules each day with breakfast, then the reminder may run each morning at 7:00 AM for 30 days. The customer thereafter may run the modify reminder process 194 to modify the specific time of day to better match their breakfast schedule. The modification may be performed by replying to the reminder notification, by logging on to the reminder system via the Internet, by calling the pharmacy and providing the information to pharmacy personnel, and/or via another suitable method. An advertisement may accompany the reminder to offer in store products or services that may be of interest to this customer, as determined by their customer history (e.g., product purchase history determined from sales records stored by the point of sale device). See, for example, FIG. 7a, which depicts a notification on a display of mobile phone, PDA, or other personal communication device. Toward the end of the recurrences, a promotional offer may be attached offering a discount on the medication to which the reminders pertain. The customer may then request (order) a refill of the medication by replying to the text message reminder. On some days, informational content may accompany the reminder instead of (or additional to) an advertisement. As discussed, the information content may comprise a warning (such as a warning related to the medication of the customer) or other health related information. Various algorithms may be implemented to select whether to include (and, if so, which) advertising content (e.g., an advertisement, promotion information). Further the algorithms may associate specific advertisements, promotions, and information content with a specific customer or reminder. In addition, a reminder may be transmitted that reminds the customer that his medication will be fully consumed soon and that he or she should purchase more medication. Pharmacy's often “hold” a customer's prescription for an extended period (such as a year) even though the customer must re-fill the prescription medication monthly or quarterly. Consequently, many customer's forget that their prescription needs renewed by their doctor. The pharmacy may send a reminder notification to the customer to remind the customer to call or visit his or her doctor to renew the prescription.

In another implementation of the reminder system 100, a car rental dealer may send reminders to its customers of their reservation dates, times and pickup locations. The customer may reply with a confirmation or cancellation of the reservation. The dealer may include advertisements and promotions for related services, such as a discount for a hotel, or an upgrade on the type of vehicle rented. The customer may reply with a request to purchase the upgrade or other product or service which may be automatically billed to a credit card on file for the customer. See, for example, FIG. 7b, which depicts a notification on a display of mobile phone, PDA, or other personal communication device.

The system may be especially useful to customers who take multiple medications who may received a different reminder notification reminding them to take each medication (which may be at different times), to request a refill one of the multitude of medications, and/or to request that their doctor renew one of the multitude of restrictions.

Thus, the present invention provides system and a method of providing notifications to a plurality of users. in one embodiment, the method comprises storing in a memory a mobile telephone number associated with each of the plurality of customers; storing in a memory one or more notification times for each customer; storing information of a medication associated with each customer; constructing a notification that includes information of the medication associated with each customer and one or more advertisement(s); at each notification time associated with each customer, transmitting the notification, including the advertisement, as a text message to the mobile telephone number associated with that customer. The method may further include receiving a text message reply from the mobile phone of the customer that acknowledges receipt of the reminder and/or includes a response to the advertisement(s).

In one embodiment of the present invention may include a method of providing notifications to a plurality of users, comprising

storing contact information for the plurality of users in a memory;

storing notification parameters for each customer in a memory;

wherein said notification parameters include information of one or more times for providing one or more reminder notifications to a customer;

constructing a reminder content;

storing a plurality of advertisements in a memory;

selecting an advertisement; and

transmitting a notification to a customer in accordance with the notification parameters for the customer and wherein the notification includes the reminder content and the selected advertisement.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of providing medication reminder notifications to a plurality of users, comprising:
storing data of one or more destinations for each of the plurality of users in a memory;
wherein at least one destination for a multitude of the plurality of users comprises a mobile telephone number;
storing in a memory, in association with each of the plurality of users, medication data that comprises information identifying one or more medications of each user;
storing in a memory, in association with each of the plurality of users, notification schedule data that comprises information for determining one or more times for providing a medication reminder notification that comprises a reminder to take a medication;
for each of the plurality of users, determining medication reminder content for a medication reminder notification based, at least in part, on the medication data in association with each user; and
for each of the plurality of users, transmitting, to the one or more destinations associated with the user, a medication reminder notification that comprises the determined medication reminder content and wherein said transmitting is performed a plurality of times and in accordance with the notification schedule data associated with the user.

2. The method according to claim 1, further comprising receiving an acknowledgement of receipt of a medication reminder notification from a first group of the plurality of users.

3. The method according to claim 2, further comprising failing to receive an acknowledgement of receipt of a medication reminder notification from a second group of the plurality of users within a predetermined time frame and retransmitting the medication reminder notification to the one or more destinations associated with each user of the second group of users.

4. The method according to claim 1, wherein the notification schedule data associated with each user includes one or more times selected by the user.

5. The method according to claim 1, further comprising transmitting a refill notification reminder to the one or more destinations associated with each of the plurality of users that comprises a reminder to order a refill of a medication.

6. The method according to claim 1, further comprising wherein the medication reminder notification transmitted to the one or more destinations associated with each user includes an advertisement.

7. The method according to claim 1, wherein the medication data for a first group of users includes information identifying a plurality of medications of the user.

8. The method according to claim 1, wherein the notification schedule data associated with at least some users includes data of time periods during which the users desire not to receive a medication reminder notification.

9. The method according to claim 1, further comprising storing in memory prescription expiration data for each user that comprises information for determining one or more times for providing a prescription expiration notification to the user that comprises a notice that a prescription of the user will expire.

10. The method according to claim 1, wherein the notification schedule data associated with each user includes data retrieved from a database that relates to the number of times a day that a user should take a medication.

11. A method of providing medication reminder notifications to a plurality of users, comprising:
storing a mobile telephone number for each of the plurality of users in a memory;
storing notification parameter data for each user in a memory;
wherein the notification parameter data for each user comprises:
first data for determining one or more times for providing a first medication reminder notification to the user that comprises a reminder to take a first medication,
second data for determining one or more times for providing a refill reminder notification to the user that comprises a reminder to order a refill of a medication,
determining a first set of one or more times to transmit the first medication reminder notification to each of the plurality of users based, at least in part, on the notification parameter data;
for each of the plurality of users and at the first set of one or more times, transmitting the first medication reminder notification to the mobile telephone of the user;
determining a refill reminder time to transmit a refill reminder notification to each of the plurality of users; and
for each of the plurality of users and at the refill reminder time, transmitting a refill reminder notification to the mobile telephone of the user.

12. The method according to claim 11, further comprising receiving an acknowledgement of receipt of the first medication reminder notification from a first group of the plurality of users.

13. The method according to claim 12, further comprising failing to receive an acknowledgement of receipt of the first medication reminder notification from a second group of the plurality of users within a predetermined time frame and retransmitting the first reminder medication notification to the mobile telephone of each user of the second group of users.

14. The method according to claim 11, wherein the notification parameter data includes one or more times selected by the user at which that user desires to receive a notification reminder.

15. The method according to claim 11, wherein the notification parameter data for each user comprises information for determining one or more times for providing a prescription expiration notification to the user that comprises a notice that a prescription for a medication will expire.

16. The method according to claim 11, wherein the notification parameter data for a first group of users further comprises information for determining one or more times for providing a second medication notification reminder to the user that includes a reminder to take a second medication.

17. The method according to claim 11, wherein the mobile telephone number of each user comprises a first destination, the method further comprising:
storing information of a second destination associated with each of the plurality of users in a memory; and
wherein said transmitting the first medication reminder notification comprises transmitting the first medication reminder notification to the second destination associated with each of the plurality of users.

18. The method according to claim 11, wherein the notification parameter data of at least some users comprises data of time periods during the user desires not to receive a reminder notification.

19. The method according to claim 11, further comprising:
receiving a reply to the refill reminder notification from the mobile telephone of each of a group of users; and
wherein the reply comprises a request to refill a medication.

20. A method of providing medication reminder notifications to a plurality of users, comprising:
for each of the plurality of users, storing a mobile telephone number in association with information identifying the user in a memory;
storing in memory in association with each user:
first data identifying a first medication of each of the plurality of users;
second data for determining when to provide a refill reminder notification that comprises a reminder to order a refill of the first medication;
for each of the plurality of users, determining a first set of one or more times to provide the first medication reminder notification that comprises a reminder to take the first medication;
for each of the plurality of users, at each of the first set of one or more times transmitting the first medication reminder notification to the mobile telephone number associated with the user;
for each of the plurality of users, determining a date to provide the refill reminder notification; and
for each of the plurality of users, transmitting the refill reminder notification to the mobile telephone associated with the user on the determined date.
